(19) United States
(12) Patent Application Publication
(10) Pub. No.: US 2006/0273976 A1
(43) Pub. Date: Dec. 7, 2006

(54) Ultra-wideband directional antenna

(76) Inventors: Wei-Jen Wang, Chu-Nan (TW); Jo-Wang Fu, Chu-Nan (TW)

Correspondence Address: J.C. Patents, Inc., Suite 250, 4 Venture, Irvine, CA, 92618, US

(21) Appl. No.: 11/438,811

(22) Filed: May 22, 2006

(30) Foreign Application Priority Data
Jun. 3, 2005 (TW) 94118307

(51) Int. Cl. H01Q 9/28; H01Q 9/16

(52) U.S. Cl. 343/795; 343/821

(57) ABSTRACT

An ultra-wideband directional antenna is disclosed, including a dielectric substrate, and antenna elements, symmetrical microstrip lines and baluns on front and back surfaces of the dielectric substrate. Each end of the symmetrical microstrip line is connected to two antenna elements. Wherein, a width of the antenna elements increases gradually outwards from sides of the antenna elements connected to the symmetrical microstrip lines. One end of the balun is connected to the middle segment of the symmetrical microstrip lines, and the other end of the balun is connected to an antenna feeding port. The ultra-wideband directional antenna with thin and compact size has a broadband property with respect to VSWR and a radiation pattern and is suitable for indoor application.

### CROSS-REFERENCE TO RELATED APPLICATION

This application claims the priority benefit of Taiwan application serial no. 94118307, filed on Jun. 3, 2005. All disclosure of the Taiwan application is incorporated herein by reference.

### BACKGROUND OF THE INVENTION

1. Field of the Invention

This invention generally relates to an antenna, and especially to an ultra-wideband directional antenna.

2. Description of Related Art

Following a progress of integrated circuit technology in recent years, wireless communication devices have become lighter, thinner and smaller, wherein plane antennas manufactured by a printed circuit method have such advantages as high level of integration and easy integration with periphery elements, and thus have gradually become a mainstream product in recent communication industry. However, after the conventional antenna is miniaturized, the antenna frequency bandwidth and radiation efficiency are inevitably decreased, thus relatively limiting the signal transmission and reception and adversely affecting the communication quality. Therefore, ultra-wideband has become a goal for a good antenna and how to increase operating frequency bandwidth of an antenna is a main subject in the recent design.

### SUMMARY OF THE INVENTION

An object of the present invention is to provide an ultra-wideband directional antenna, which possesses an ultra frequency bandwidth with a thin and a compact size, and is suitable for indoor application.

The present invention provides an ultra-wideband directional antenna, which comprises a dielectric substrate, two first antenna elements, a first symmetrical microstrip line, a first balun, two second antenna elements, a second symmetrical microstrip line, and a second balun. The dielectric substrate has a front surface and a back surface. The first antenna elements, the first symmetrical microstrip line and the first balun are disposed on the front surface of the dielectric substrate. The second antenna elements, the second symmetrical microstrip line and the second balun are disposed on the back surface of the dielectric substrate. Each end of the first symmetrical microstrip line is respectively connected to one of the first antenna elements, wherein the width of the first antenna elements increases gradually outwards from the sides of the first antenna elements connecting to the first symmetrical microstrip line. An end of the first balun is connected to a middle segment of the first symmetrical microstrip line, the other end of the first balun is connected to an antenna feeding port, and the first balun and the first antenna elements are respectively disposed at different sides of the first symmetrical microstrip line. Each end of the second symmetrical microstrip line is respectively connected to one of the second antenna elements, wherein the width of the second antenna elements increases gradually outwards from the sides of the second antenna elements connecting to the second symmetrical microstrip line. An end of the second balun is connected to a middle segment of the second symmetrical microstrip line, the other end of the second balun is connected to an antenna feeding port, and the second balun and the second antenna elements are disposed at the same side of the second symmetrical microstrip line.

In summary, the ultra-wideband directional antenna of the present invention utilizes a design of which the width of the antenna element increases gradually outwards from a side connecting to the first symmetrical microstrip lines, a wider frequency band can be obtained. Further, the ultra-wideband directional antenna of the present invention has advantages of lightness, thinness, compact size and indoor application.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIGS. 1A and 1B are schematic drawings of front and back surfaces of an ultra-wideband directional antenna according to an embodiment of the present invention.

FIG. 2 is a cross-sectional view of an ultra-wideband directional antenna according to another embodiment of the present invention.

### DESCRIPTION OF THE P EMBODIMENTS

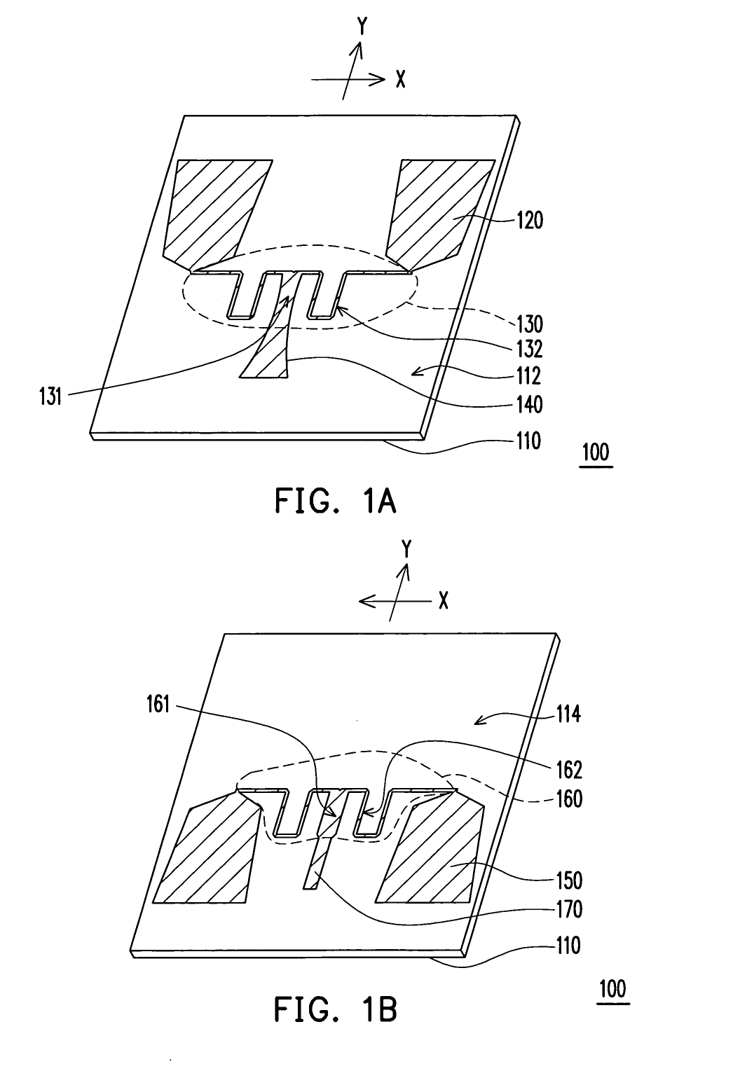

As shown in FIGS. 1A and 1B, an ultra-wideband directional antenna 100 comprises a dielectric substrate 110, two first antenna elements 120, a first symmetrical microstrip line 130, a first balun 140, two second antenna elements 150, a second symmetrical microstrip line 160, and a second balun 170. The dielectric substrate 110 has a front surface 112 and a back surface 114. Wherein, the dielectric substrate 110 can be a hard substrate used for a print circuit board or other dielectric substrates, such as dielectric substrates composed with glass fiber and epoxy resin. A function of the dielectric substrate 110 is to serve as a loading substrate for antenna patterns, and to electrically insulate the antenna patterns disposed at the front surface 112 and the back surface 114.

The first antenna elements 120, the first symmetrical microstrip line 130 and the first balun 140 are disposed on the front surface 112 of the dielectric substrate 110. The second antenna elements 150, the second symmetrical microstrip line 160 and the second balun 170 are disposed on the back surface 114 of the dielectric substrate 110. Wherein, the first antenna elements 120, the first symmetrical microstrip line 130 and the first balun 140 are formed, for example, by patterning a conductive layer (not shown) on the front surface 112 of the dielectric substrate 110, and the second antenna elements 150, the second symmetrical microstrip line 160 and the second balun 170 are formed by the same method on the back surface 114 of the dielectric substrate 110. For example, the conductive layer can be the copper foil for a common print circuit board or other suitable materials.

Each end of the first symmetrical microstrip line 130 is respectively connected to one of the first antenna elements 120, wherein the width of the first antenna elements 120 increases gradually outwards from the sides of the first antenna elements 120 connecting to the first symmetrical microstrip line 130. For example, the first symmetrical microstrip line 130 extends in the X direction and the width of the first antenna elements 120 gradually increases from the sides of the first antenna elements 120 connecting to the first symmetrical microstrip line 130 towards the Y direction. In the present invention, because the shape of the first antenna elements 120 has an increasing width, the effect of increasing operating frequency band of the ultra-wideband directional antenna 100 can therefore be achieved.

Further, the shape of the first antenna elements 120 can be polygon or other non-regular shapes, as long as a characteristic that the width of the first antenna elements 120 increases gradually outwards from the sides of the first antenna elements 120 connecting to the first symmetrical microstrip line 130 is met. For example, the shape of the first antenna elements 120 in the embodiment of the present invention is pentagon. Further, it is better that the distance between two first antenna elements 120 is less than half of a wavelength of the received/transmitted signals. Further, the first symmetrical microstrip line 130, for example, connects a apex of the first antenna elements 120. Furthermore, when a signal matching problem occurs, the problem can be solved by adding a first winding matching segment 132 design on the first symmetrical microstrip line 130, and a first matching segment 131 can be extended from the middle segment of the first symmetrical microstrip line 130 towards the Y direction, and the first balun 131 and the first antenna elements 120 are respectively disposed at different sides of the first winding matching segment 132.

An end of the first balun 140 is connected to an end of the first matching segment 131 in the middle segment of the first symmetrical microstrip line 130, and other end of the first balun 140 is connected to the antenna feeding port (not shown), and the first balun 140 and the first antenna elements 120 are respectively disposed at different sides of the first symmetrical microstrip line 130. For example, the width of the first balun 140 increases gradually outwards from a side connecting to the first symmetrical microstrip lines 130, as shown in FIG. 1A. In general, a wider end of the first balun 140 can be connected to the negative electrode of the antenna feeding port.

Two ends of the second symmetrical microstrip line 160 are respectively connected to one of the second antenna elements 150. Wherein, the width of the second antenna elements 150 increases gradually outwards from the sides of the second antenna elements 150 connecting to the second symmetrical microstrip line 160. For example, the second symmetrical microstrip line 160 extends in the X direction, and the width of the second antenna elements 150 gradually increases from the sides of the second antenna elements 150 connecting to the second symmetrical microstrip line 160 towards the negative Y direction. In the present invention, because the shape of the second antenna elements 150 has increasing width, the effect of increasing the operating frequency band of the ultra-wideband directional antenna 100 can therefore be achieved. An end of the second balun 170 is connected to the middle segment of the second symmetrical microstrip line 160, the other end of the second balun 170 is connected to the antenna feeding port (not shown), and the second balun 170 and the second antenna elements 150 are disposed at the same side of the second symmetrical microstrip line 160. Of course, when the wider end of the first balun 140 is connected to the negative electrode of the antenna feeding port, the end of the second balun 170 far away from the second symmetrical microstrip line 160 is connected to the positive electrode of the antenna feeding port.

Further, the shape of the second antenna elements 150 and the distance between two of the second antenna elements 150 can be designed as the first antenna elements 120. Further, the connecting method of the second symmetrical microstrip line 160 and the second antenna elements 150 and the signal matching method, which are implemented by the second winding matching segment 162 and a second matching segment 161, all can utilize the design of the first symmetrical microstrip lines 130. In details, when the second matching segment 161 exists in the design, an end of the second balun 170 is connected to the second matching segment 161.

In the embodiment of the present invention, the first balun 140 and the second balun 170 can be correspondingly disposed in the same position of the dielectric substrate 110. Further, the first symmetrical microstrip line 130 and the second symmetrical microstrip line 160 are correspondingly disposed in the same position of the dielectric substrate 110.

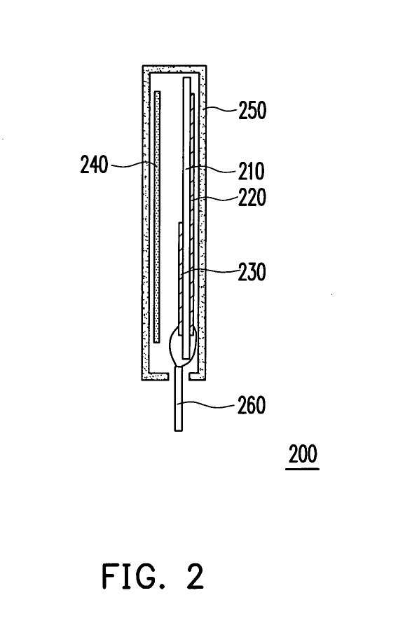

As shown in FIG. 2, similar to the ultra-wideband directional antenna as shown in FIGS. 1A and 1B, an ultra-wideband directional antenna 200 of the present invention comprises a dielectric substrate 210, two antenna patterns 220 and 230 disposed on two sides of the dielectric substrate 210, which are equivalent to the first and second antenna elements 120 and 150, the first and second symmetrical microstrip lines 130 and 160, and the first and second baluns 140 and 170 of the ultra-wideband directional antenna 100. In addition, the ultra-wideband directional antenna 200 further comprises a reflecting element 240. The reflecting element 240 can be disposed, with a distance, either over the front surface or under the back surface of the dielectric substrate 210. Further, the area of the reflecting element 240 can be less than the area of the dielectric substrate 210 and the material is, for example, a conductive material. Furthermore, the reflecting element 240 and the dielectric substrate 210 are preferably disposed in parallel, and it is better that the distance between the reflecting element 240 and the dielectric substrate 210 is less than 0.1 time of the wavelength of the received/transmitted signals.

Further, the reflecting element 240 and the dielectric substrate 210 can be disposed in a case 250, and the antenna patterns 220 and 230 are connected to a signal line 260 through the antenna feeding port.

In summary, in the ultra-wideband directional antenna of the present invention, because the width of the antenna element increases gradually outwards from a side connecting to the symmetrical microstrip lines, a wider operating frequency band can be obtained. Further, the ultra-wideband directional antenna of the present invention has such advantages as lightness, thinness, compact size and indoor application. Furthermore, because the outer shape and the design principle of the symmetrical microstrip lines and the baluns are simple, the difficulty of the design and modification to different products can be reduced.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. An ultra-wideband directional antenna, comprising:
a dielectric substrate, having a front surface and a back surface;
two first antenna elements, disposed on the front surface of the dielectric substrate;
a first symmetrical microstrip line, disposed on the front surface of the dielectric substrate, wherein two ends of the first symmetrical microstrip line are respectively connected to the first antenna elements, and a width of the first antenna elements increases gradually outwards from the sides of the first antenna elements connecting to the first symmetrical microstrip line;
a first balun, disposed on the front surface of the dielectric substrate, wherein one end of the first balun is connected to a middle segment of the first symmetrical microstrip line, the other end of the first balun is connected to an antenna feeding port, and the first balun and the first antenna elements are respectively disposed at different sides of the first symmetrical microstrip line;
two second antenna elements, disposed on the back surface of the dielectric substrate;
a second symmetrical microstrip line, disposed on the back surface of the dielectric substrate, wherein two ends of the second symmetrical microstrip lines are respectively connected to the second antenna elements, and a width of the second antenna elements increases gradually outwards from the sides of the second antenna elements connecting to the second symmetrical microstrip line;
a second balun, disposed on the back surface of the dielectric substrate, wherein, one end of the second balun is connected to a middle segment of the second symmetrical microstrip line, the other end of the second balun is connected to an antenna feeding port, and the second balun and the second antenna elements are disposed at the same side of the second symmetrical microstrip line.

2. The ultra-wideband directional antenna of claim 1, wherein a shape of the first antenna elements comprises a polygon.

3. The ultra-wideband directional antenna of claim 2, wherein a shape of the first antenna elements comprises a pentagon.

4. The ultra-wideband directional antenna of claim 3, wherein the first symmetrical microstrip line connects an apex of the first antenna elements.

5. The ultra-wideband directional antenna of claim 1, wherein a shape of the second antenna elements comprises a polygon.

6. The ultra-wideband directional antenna of claim 5, wherein, a shape of the second antenna elements comprises a pentagon.

7. The ultra-wideband directional antenna of claim 6, wherein the second symmetrical microstrip line connects an apex of the second antenna elements.

8. The ultra-wideband directional antenna of claim 1, wherein the first symmetrical microstrip line has a first winding matching segment.

9. The ultra-wideband directional antenna of claim 1, wherein the second symmetrical microstrip line has a second winding matching segment.

10. The ultra-wideband directional antenna of claim 1, wherein a distance between the first antenna elements is less than half of a wavelength of received/transmitted signals.

11. The ultra-wideband directional antenna of claim 1, wherein a distance between the second antenna elements is less than half of a wavelength of received/transmitted signals.

12. The ultra-wideband directional antenna of claim 1, further comprising a reflecting element, disposed, with a distance, either over the front surface or under the back surface of the dielectric substrate.

13. The ultra-wideband directional antenna of claim 12, wherein an area of the reflecting element is smaller than an area of the dielectric substrate.

14. The ultra-wideband directional antenna of claim 12, wherein the distance between the reflecting element and either the front surface or the back surface of the dielectric substrate is less than 0.1 time of the wavelength of received/transmitted signals.

15. The ultra-wideband directional antenna of claim 1, wherein a width of the first balun increases gradually outwards from a side connecting to the first symmetrical microstrip line.

16. The ultra-wideband directional antenna of claim 1, wherein the first balun and the second balun are correspondingly disposed in the same position of the dielectric substrate.

17. The ultra-wideband directional antenna of claim 1, wherein the first symmetrical microstrip line and the second symmetrical microstrip line are correspondingly disposed in the same position of the dielectric substrate.

18. The ultra-wideband directional antenna of claim 1, wherein the middle segment of the first symmetrical microstrip line has a first matching segment.

19. The ultra-wideband directional antenna of claim 1, wherein the middle segment of the second symmetrical microstrip line has a second matching segment.
